(19) United States
(12) Patent Application Publication
(10) Pub. No.: US 2005/0039590 A1
(43) Pub. Date: Feb. 24, 2005

(54) Lever-operated paper punch

(76) Inventor: Yang-Ming Weng, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 10/646,909

(22) Filed: Aug. 22, 2003

(51) Int. Cl. B26D 5/08; B26F 1/14

(52) U.S. Cl. 83/684; 83/588; 83/613

(57) ABSTRACT

A lever-operated paper punch generally comprises a base plate, a male die, a cover, a hook pin, a spring and a lever. Wherein the lever is rotatably disposed on the hook pin and which can be rotated to abut flush against the top surface of the cover so as to eliminate a space between the lever and the base plate, such that the paper punch of the present invention can be well preserved by putting an end to a possibility of injury caused by inserting fingers into the spacing between the lever and the base plate.

### BACKGROUND OF THE INVENTION

1. Field of the Invention

The present invention relates to a lever-operated paper punch, and more particularly to a lever-operated paper punch wherein a lever of which can be folded to abut flush against a base plate of the punch.

2. Description of the Prior Arts

A conventional lever-operated paper punch as shown in FIG. 1, which normally includes a lever 11 disposed on a housing 12, the lever 11 can be recovered to original position after being depressed. Wherein a space 13 needs to be defined between the housing 12 and the lever 11 for allowing the punch action of the lever 11. Most of the paper punches of the kind are provided for children's using. The space 13 will still exist when the paper punch is being used, thereby the children maybe insert their fingers in the space 13 just out of curiosity and thus possibly be injured by the paper punch.

In addition, when the paper punch is not used and need to be put away, since the lever 11 cannot be folded, there will be a space left between a push portion 111 of the lever 11 and the housing 12. In this case, when the child fetches the paper punch, the lever 11 may stab him/her.

The present invention has arisen to mitigate and/or obviate the afore-described disadvantages of the conventional lever-operated paper punch.

### SUMMARY OF THE INVENTION

In accordance with one aspect of the present invention, there is provided with a lever-operated paper punch, which generally includes a base plate, a male die, a cover, a hook pin, a spring and a lever. Wherein the lever is rotatably disposed on the hook pin and can be rotated to abut flush against the top surface of the cover so as to eliminate a space between the lever and the base plate.

The primary object of the present invention is to provide a lever-operated paper punch, wherein a lever of the paper punch can be folded when the paper punch is not being used and needs to be put away, so as to put an end to possibilities of injury caused by inserting fingers into the spacing between the lever and the base plate.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a perspective view of a conventional paper punch;

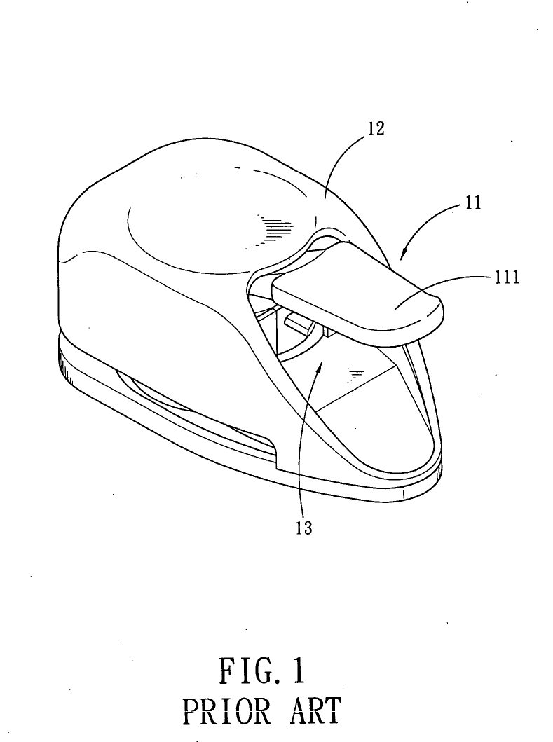

FIG. 2 is an exploded view of a lever-operated paper punch in accordance with a first embodiment of the present invention;

FIG. 3 is a perspective assembly view of the lever-operated paper punch in accordance with a first embodiment of the present invention;

FIG. 4 is a first cross-sectional view of the lever-operated paper punch in accordance with a first embodiment of the present invention;

FIG. 5 is a second cross-sectional view of the lever-operated paper punch in accordance with a first embodiment of the present invention;

FIG. 6 is a third cross-sectional view of the lever-operated paper punch in accordance with a first embodiment of the present invention;

FIG. 7 is a fourth cross-sectional view of the lever-operated paper punch in accordance with a first embodiment of the present invention;

FIG. 8 is a cross-sectional view of a lever-operated paper punch in accordance with a second embodiment of the present invention;

FIG. 9 is another cross-sectional view of the lever-operated paper punch in accordance with a second embodiment of the present invention;

### DETAILED DESCRIPTION OF THE PREFERRED EMBODIMENTS

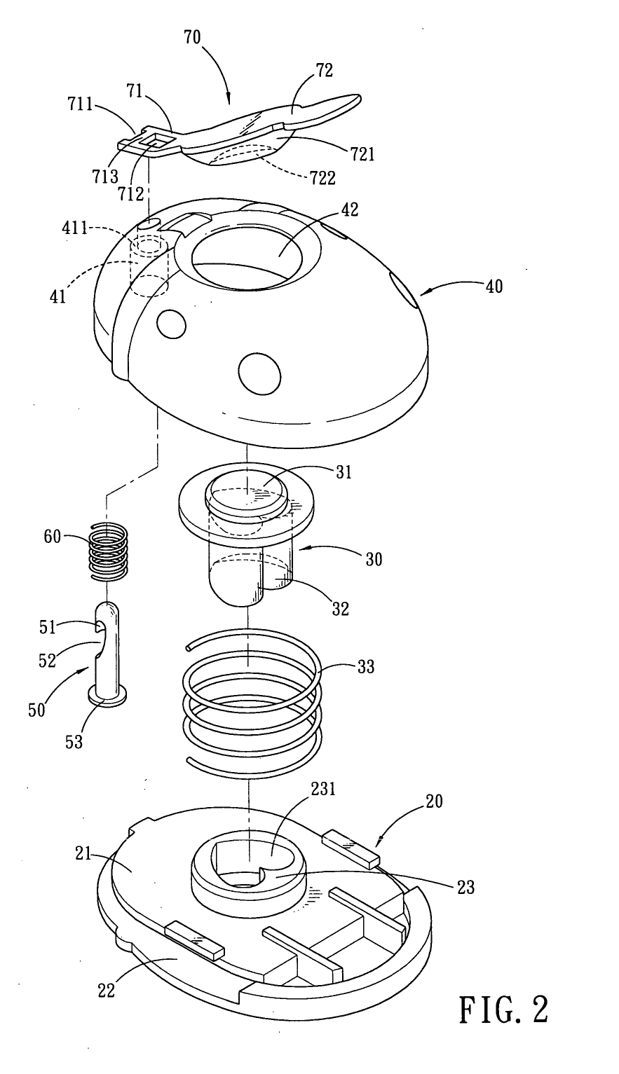

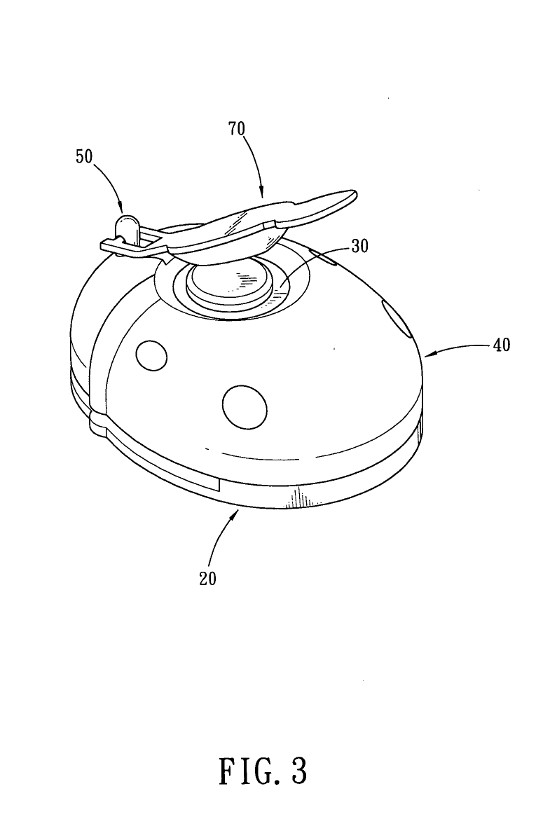

Referring to FIGS. 2-4, wherein a lever-operated paper punch in accordance with a first embodiment of the present invention is shown and generally comprising a base plate 20, a male die 30, a cover 40, a hook pin 50, a spring 60 and a lever 70.

The base plate 20 includes a first platform 21 and a second platform 22. Wherein in proximity to center of the first platform 21 is provided with a female die 23 which having a through die hole 231 defined therethrough, whereas on the second platform 22 is defined with an outlet 221 for passage of the scrap papers, which is corresponding to the die hole 231 of the first platform 21. Furthermore, between the first platform 21 and the second platform 22 a slit 24 is formed thereof for defining a space for insertion of documents.

The male die 30 is provided with a flange 31 at its top surface, and at the lower end of the male die 30 is defined with a punch portion 32, the punch portion 32 is configured with corresponding to the contour of the die hole 231 of the base plate 20. A spring is mounted on the male die 30, such that the male die 30 can be movably disposed in the female die 23 of the base plate 20.

The cover 40 is provided at its front end with a hole 41, on the inner wall of the hole 41 is defined with a shoulder 411, in the proximity to the center of the cover a punch hole 42 is formed. The cover 40 is disposed on the base plate 20, and the punch hole 42 serves to engage with the flange 31 of the male die 30.

The hook pin 50 is defined at its upper portion with a hook portion 51, at the hook portion 51 is defined with a gap 52, at the lower portion of the hook pin 50 is formed with a flange 53. The hook pin 50 is movably engaged in the hole 41 of the cover 40 with the hook portion 51 protruding out of the hole 41.

The spring 60 is compressively biased on the hook pin 50 with one end abutting against the flange 53 of the hook pin 50 and with another end abutting against the shoulder 411 in the hole 41 of the cover 40.

The lever 70 includes an engaging portion 71 connected with a push portion 72. At the connecting portion of the engaging portion 71 with the push portion 72 is defined with a projection 73. Wherein at free end of the engaging portion 71 thereof a notch 711 is defined, at proximity to the notch 711 is defined with an engaging hole 712, a rib 713 is formed between the engaging hole 712 and the notch 711. Furthermore, on the push portion 72 thereof an abutting portion 721 is defined, and in the abutting portion 721 thereof a groove 722 is formed in corresponding to the contour of flange 31 of the male die 30. The lever 70 is rotatably engaged in the hook portion 51 of the hook pin 50 with its rib 713 engaging in the gap 52 of the hook pin 50. The notch 711 serves to engage with the hook portion 51, and the projection 73 is employed to abut against a top surface of the cover 40.

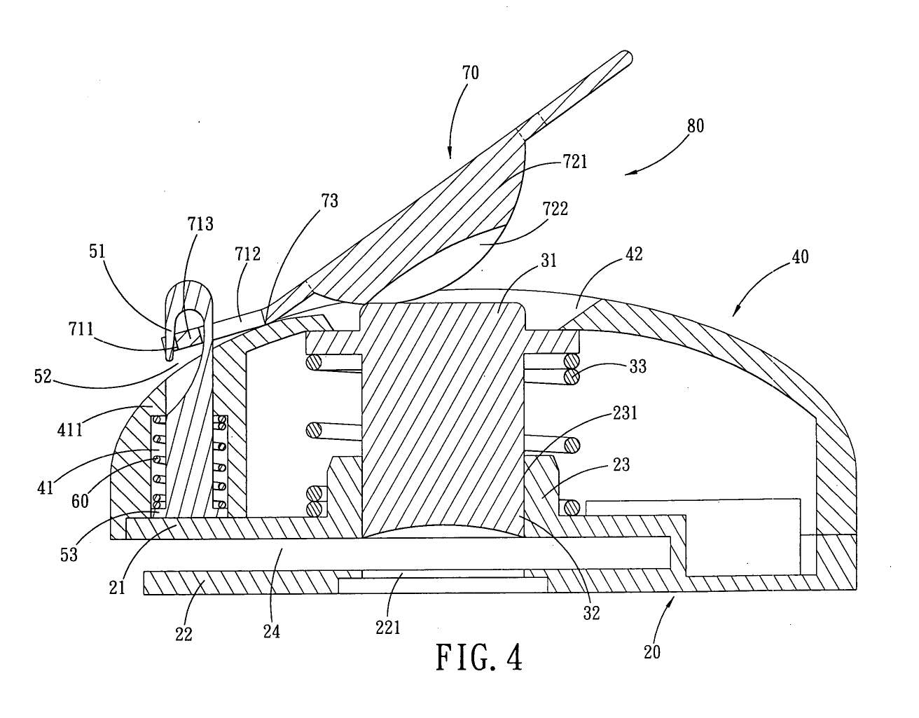

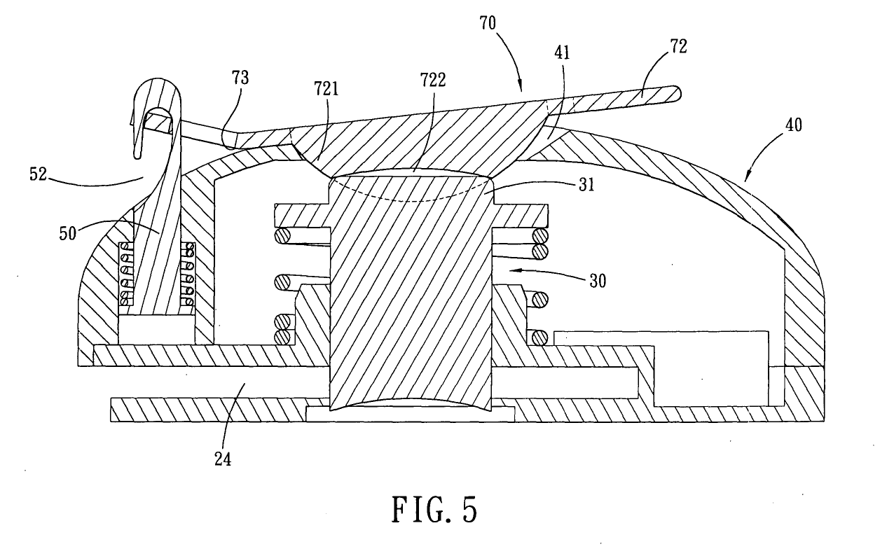

Referring to FIGS. 4-5, in operation, the user rotates the lever 70 by a certain angle and causes a synchronous rotation of the hook pin 50, such that makes the gap 52 of the hook pin 50 stand with its back to the punch hole 41 of the cover 40 and with its projection 73 abutting against the top surface of the cover 40, whereas the groove 722 of the abutting portion 721 is corresponding to the projection 31 of the male die 30, and thus define a space 80 between the push portion 72 and the cover 40. And then inserts the papers to be punched in the slit 24 of the base plate 20 and followed by pressing the push portion 72 of the lever 70, such that the abutting portion 721 will drive the male die 30 to move downward, by this way, a paper shaped in the contour of the punch portion 32 is punched out.

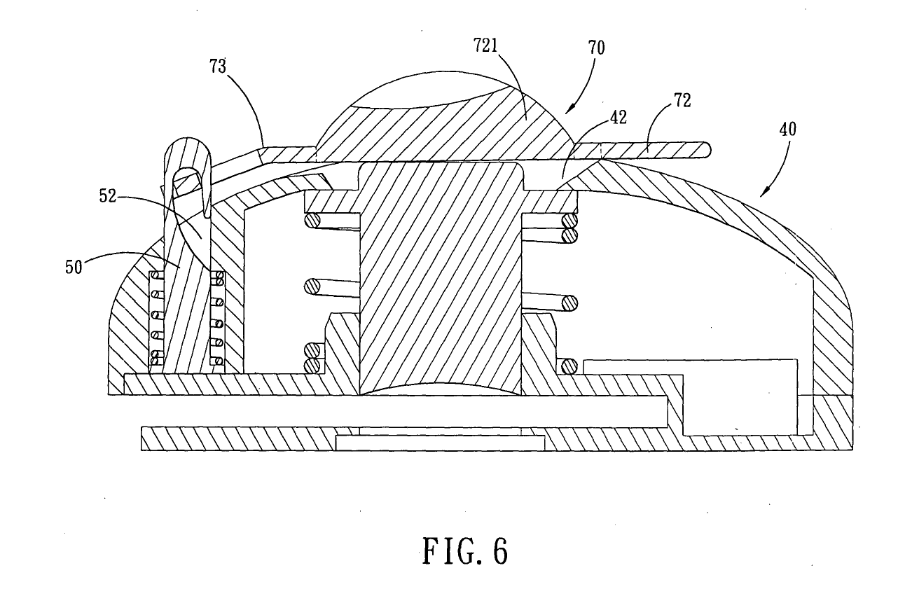

Referring to FIG. 6, when the user wants to put the paper punch away, he/she can rotate the lever 70 by a certain angle and causes a synchronous rotation of the hook pin 50, such that makes the gap 52 of the hook pin 50 face toward the punch hole 41 of the cover 40. At the moment, the projection 73 as well as the abutting portion 721 of the lever 70 will face upward, such that makes the push portion 72 abut flush against the top surface of the cover 40, and meanwhile the space 80 between the cover 40 and the push portion 72 is disappeared. And thus prevents hurt of the children's finger caused by inserting into the space 80.

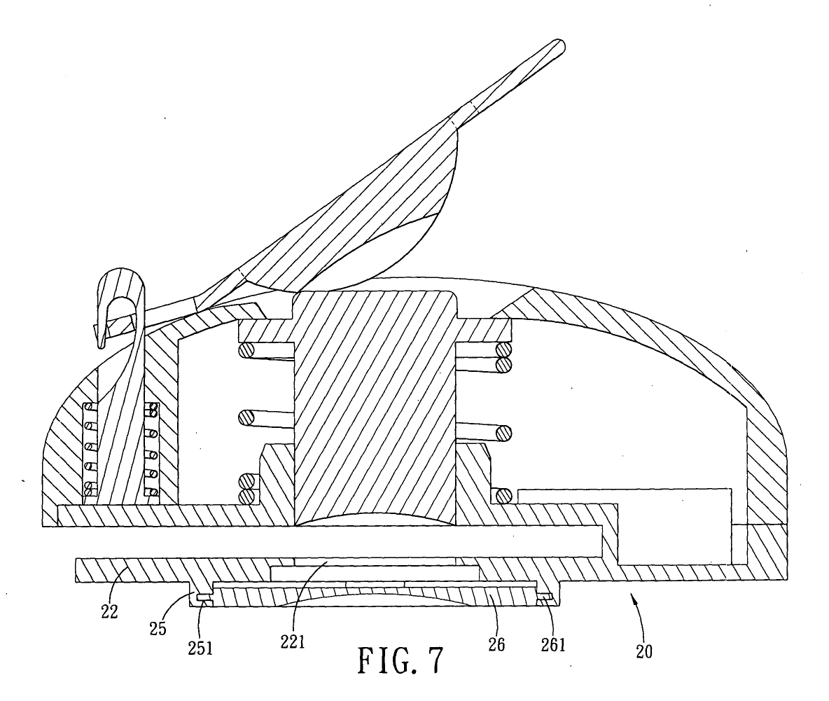

It will be noted that, as shown in FIG. 7, wherein at the second platform 22 of the base plate 20 with proximity to the outlet 221 can be provided with an engaging portion 25. On the engaging portion 25 grooves 251 are defined for engaging with a protecting cover 26. At the periphery of the protecting cover 26 is provided with an engaging portion 261 for engaging with that engaging portion 25 of the base plate 20. And thus by covering the outlet 221 with the protecting cover 26 so as to prevent hurt of the children's finger caused by inserting into the outlet 221.

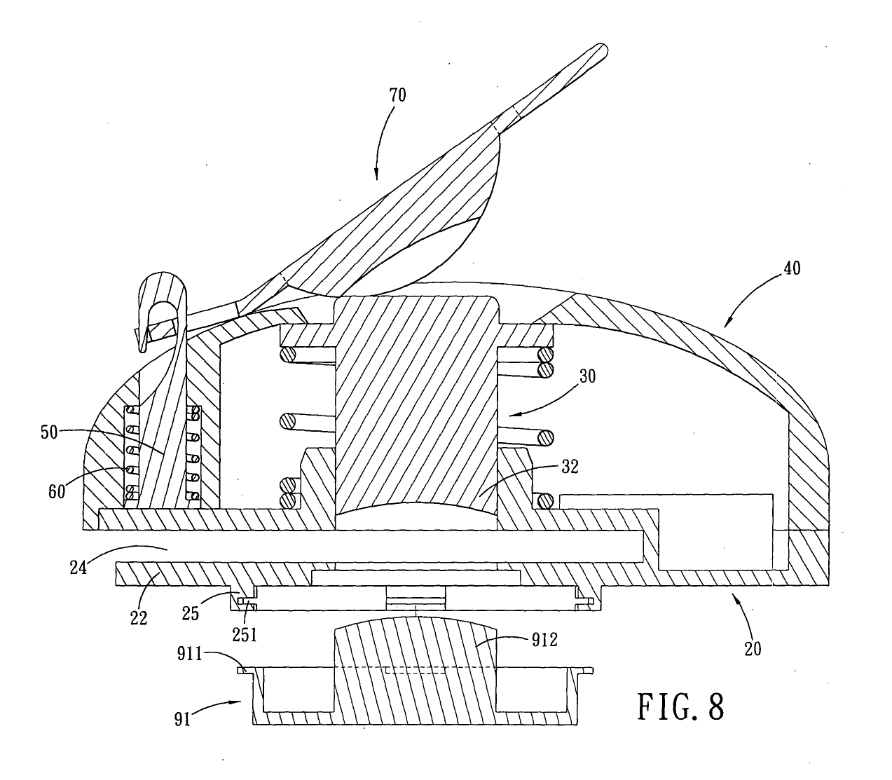

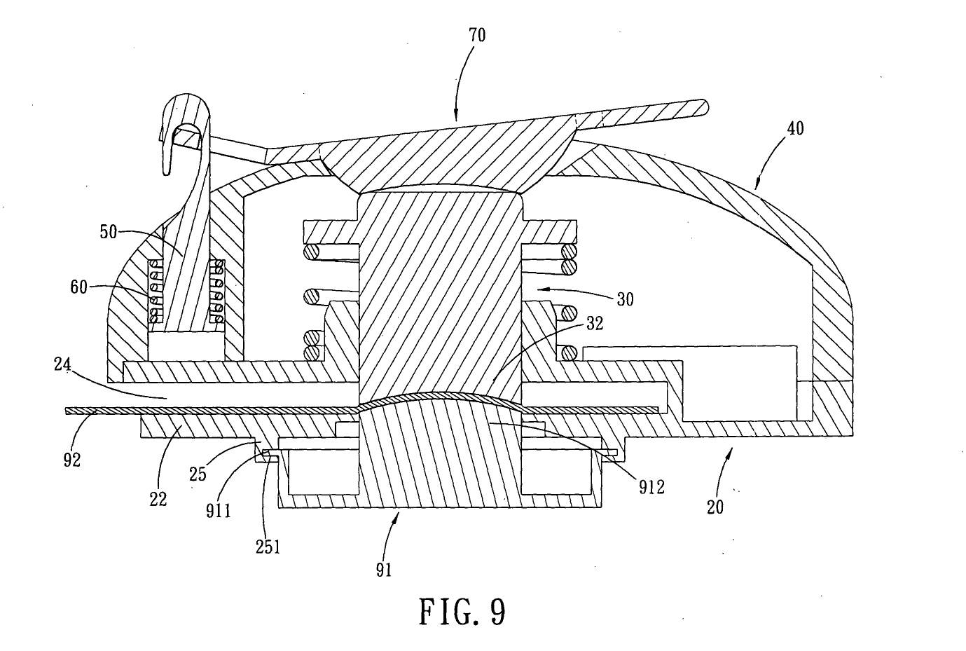

Referring to FIGS. 8-9, wherein a lever-operated paper punch in accordance with a second embodiment of the present invention is shown and generally structurally similar with the paper punch of the first embodiment of the present invention, which also includes a base plate 20, a male die 30, a cover 40, a hook pin 50, a spring 60 and a lever 70. Thus further remarks on this matter would seem superfluous, the distinction of the paper punch of the second embodiment from that of the first embodiment will be described as follows:

At the lower end of a second portion 22 of the base plate 20 is defined with an engaging portion 25. In the engaging portion 25 grooves 251 are formed for engaging with a bed die 91. The bed die 91 is provided at its periphery with an engaging portion 911 for engaging with that engaging portion 25 of the base plate 20, at the proximity to the center of the bed die 91 a projection 912 is defined thereon by protruding into a slit 24 of the base plate 20. The top surface of the projection 912 is shaped with corresponding to the contour of the punch portion 32 of the male die 30. By such arrangements, the user can insert papers 92 into the slit 24 of the base plate 20 and followed by pressing down the lever 70 so as to drive the male die 30 to move downward, by this way, a paper shaped in the contour of the punch portion 32 is punched out. In addition, the paper punch of the second embodiment of the present invention can be put away, in like manner, by rotating a certain angle of the lever 70 to eliminate the space between the push portion 72 and the cover 40, so as to prevent the hurt on the children caused by inserting fingers therein.

While we have shown and described various embodiments in accordance with the present invention, it should be clear to those skilled in the art that further embodiments may be made without departing from the scope of the present invention.

1. A lever-operated paper punch comprising:
a base plate having a female die, at a lower end of the female die formed with a slit for defining a space for insertion of documents;
a male die provided at its top surface with a flange, and at a lower end of the male die defined with a punch portion, a spring mounted on the male die, such that the male die can be movably disposed in the female die of the base plate;
a cover disposed on the base plate and provided at its front end with a hole, a punch hole formed on the cover for engaging with the flange of the male die;
a hook pin for engaging in the hole of the cover with its hook portion protruding there out;
a spring compressively biased on the hook pin;
a lever including an engaging portion connected with a push portion, the engaging portion rotatably engaged in the hook portion of the hook pin, on the push portion with corresponding to the flange of the male die defined with an abutting portion for abutting against and driving the male die.

2. The lever-operated paper punch as claimed in claim 1, wherein at a free end of the engaging portion thereof a notch is defined, at proximity to the notch is defined with an engaging hole, a rib is formed between the engaging hole and the notch for engaging in the gap of the hook pin, the notch serves to engage with the hook portion of the hook pin.

3. The lever-operated paper punch as claimed in claim 1, wherein at the connecting portion of the engaging portion with the push portion is defined with a projection for abutting against the top surface of the cover.

4. The lever-operated paper punch as claimed in claim 1, wherein at the lower end of the base plate is provided with an engaging portion for engaging with a protecting cover.

5. The lever-operated paper punch as claimed in claim 1, wherein at the lower end of the base plate is provided with an engaging portion for being engaged with a bed die, on the bed die is further formed with a projection that protruding into the slit of the base body for insertion of documents.
